(19) United States
(12) Patent Application Publication
(10) Pub. No.: US 2025/0391931 A1
(43) Pub. Date: Dec. 25, 2025

(54) ENERGY STORAGE SYSTEM BALANCE MANAGEMENT METHOD BASED ON CLOUD-EDGE COLLABORATION AND SYSTEM THEREOF

(71) Applicant: ZHEJIANG JINKO ENERGY STORAGE CO., LTD., Haining City (CN)

(72) Inventor: Yingfei CUI, Haining City (CN)

(73) Assignee: ZHEJIANG JINKO ENERGY STORAGE CO., LTD., Haining City (CN)

(21) Appl. No.: 18/933,781

(22) Filed: Oct. 31, 2024

(30) Foreign Application Priority Data
Jun. 19, 2024 (CN) 202410789570.7

(51) Int. Cl. H01M 10/42

(52) U.S. Cl. CPC H01M 10/425; H01M 2010/4271

(57) ABSTRACT

Energy storage system balance management method based on cloud-edge collaboration and system are provided. The balance management method includes: acquiring operating data before and after balance of energy storage system; evaluating, according to operating data before and after balancing energy storage system and balance time, balance effect of energy storage system to obtain balance optimization parameter; and controlling ON and OFF of balancing of energy storage system at edge end according to balance optimization parameter. According to balance optimization parameter, differences in cell consistency between battery clusters at edge end can be reduced, and circulating current between battery clusters at edge end can be reduced, thereby preventing damage to batteries due to excessive circulating current between battery clusters and ensuring use performance and safety of energy storage system. Reliable reference can be provided for stack controller at edge end to analyze inter-cell difference, and balance control accuracy can be improved.

### CROSS-REFERENCE TO RELATED APPLICATIONS

The present application claims priority to Chinese Patent Application No. 202410789570.7, filed on Jun. 19, 2024, the content of which is incorporated herein by reference in its entirety.

### FIELD

The present disclosure relates to the technical field of energy storage, and in particular to an energy storage system balance management method based on cloud-edge collaboration and a system thereof.

### BACKGROUND

The statements in this section merely provide background information related to the present disclosure and may not constitute prior art.

With the continuous development of a power system, an energy storage system, as an important part of an energy storage technology, is widely applied to the field of energy storage. For the energy storage system, generally, firstly, a plurality of cells are combined into an entire battery module, then, a plurality of battery modules are installed inside an entire battery pack in series and parallel, electrical components and structural fixings are installed, and finally, the battery pack is installed on a battery rack to form an entire battery cluster, thereby forming an entire energy storage system.

### SUMMARY

This section provides a general summary of the disclosure and is not a comprehensive disclosure of its full scope or all of its features.

In view of this, the present disclosure provides an energy storage system balance management method based on cloud-edge collaboration and a system thereof, to solve the problem of differences in battery consistency.

In a first aspect, the present disclosure provides an energy storage system balance management method based on cloud-edge collaboration, the method including: acquiring operating data before and after balance of an energy storage system; evaluating, according to operating data before and after balancing the energy storage system and a balance time, a balance effect of the energy storage system to obtain a balance optimization parameter, including: recording an inter-cell capacity difference array before the balance starts; starting to balance an inter-cell capacity, and when an ON time of balance of the inter-cell capacity reaches a preset time, triggering balance effect evaluation; confirming a theoretical balance capacity and an actual balance capacity reduction value; and obtaining the balance optimization parameter according to the theoretical balance capacity and the actual balance capacity reduction value; and controlling ON and OFF of the balance of the energy storage system at an edge end according to the balance optimization parameter, including: acquiring a cloud-based state of health (SOH) and the balance optimization parameter; updating SOHs of respective cells in a battery stack according to the cloud-based SOH and the balance optimization parameter; obtaining an inter-cell capacity difference under a characteristic operating condition according to the updated SOHs of the respective cells in the battery stack; confirming a passive balance time required by each cell according to the inter-cell capacity difference; and controlling ON and OFF of balance of each cell according to the passive balance time required by the cell.

In some embodiments, the theoretical balance capacity is: ΔCap_{init,k}=BalCurr×k×x; where ΔCap_{init,k} denotes the theoretical balance capacity; BalCurr denotes a balance current; and k×X denotes the preset time; and the actual balance capacity reduction value is: ΔCap_{k,i}=Cap_{init,i}−Cap_{k,i}; where ΔCap_{k,i} denotes an actual inter-cell capacity difference reduction value after this balance; Cap_{init,i} denotes the inter-cell capacity difference array; and Cap_{k,i} denotes the inter-cell capacity difference.

In some embodiments, the obtaining the balance optimization parameter according to the theoretical balance capacity and the actual balance capacity reduction value includes: obtaining a balance time optimization coefficient according to the theoretical balance capacity and the actual balance capacity reduction value; and obtaining the balance optimization parameter according to the balance time optimization coefficient.

In some embodiments, the balance time optimization coefficient is:

$${φ}_{k , i} = \frac{Δ {Cap}_{init , k}}{Δ {Cap}_{k , i}} ;$$

where φ_{k,i} denotes the balance time optimization coefficient, ΔCap_{init,k} denotes the theoretical balance capacity, and ΔCap_{k,i} denotes the actual balance capacity reduction value; and the balance optimization parameter is:

$${φ}_{i} = \frac{1}{n} \cdot {\sum }_{k = 1}^{n} {φ}_{k , i} ;$$

where φᵢ denotes a balance optimization coefficient, k denotes a number of times balance optimization is triggered, and n denotes a total number of times balance optimization is triggered.

In some embodiments, the updating SOHs of respective cells in a battery stack according to the cloud-based SOH and the balance optimization parameter includes: obtaining a balance SOH according to a number of updates of the SOHs of the respective cells in historical 30 days and SOH₁, SOH₂, . . . , and SOHₙ, including: when n≥3 and max(SOH_{i,l},SOH_{i,2}, . . . , SOH_{i,n})−min(SOH_{i,l},SOH_{i,2}, . . . , SOH_{i,n})≤1, the balance SOH=a local SOH, where * denotes a cell number, and SOH_{i,l} denotes the SOH of the i^{th} cell most recently calculated in historical 30 days; when 1≤n≤2, the balance SOH=90%×the local SOH+10%×the cloud-based SOH; and when n=0, the balance SOH=50%×the local SOH+50%×the cloud-based SOH.

In some embodiments, the inter-cell capacity difference is: ΔCapᵢ=SOH₄×Cap_{N}·(SIC₄−SICₘᵢₙ); where SOH denotes the balance SOH, denotes the cell number, Cap_{N} denotes a rated capacity, and SOCₘᵢₙ denotes a minimum state of charge (SOC) in the battery stack; and the passive balance time required by each cell is:

$${t}_{BAL , i} = \frac{{φ}_{i} \cdot Δ {Cap}_{i}}{{i}_{Bal}} ;$$

where φᵢ denotes a balance optimization coefficient, ΔCapᵢ denotes the inter-cell capacity difference, and i_{Bal} denotes a balanced average current.

In some embodiments, the controlling ON and OFF of balance of each cell according to the passive balance time required by the cell includes: when, t_{BAL,i}<0, turning on balance of the corresponding cell; and when t_{BAL,i}=0, turning off balance of the corresponding cell.

In a second aspect, the present disclosure further provides an energy storage system balance management system based on cloud-edge collaboration, configured to perform the energy storage system balance management method based on cloud-edge collaboration described above, the system including: an operating data acquisition module configured to acquire operating data before and after balance of an energy storage system; a balance effect evaluation module coupled to the operating data acquisition module and configured to evaluate, according to operating data before and after balancing the energy storage system and a balance time, a balance effect of the energy storage system to obtain a balance optimization parameter, the balance effect evaluation module including a recording unit, a trigger unit, a first confirmation unit, and a first calculation unit, wherein the recording unit is configured to record an inter-cell capacity difference array before the balance starts; the trigger unit is coupled to the recording unit and is configured to start to balance an inter-cell capacity, and when an ON time of balance of the inter-cell capacity reaches a preset time, trigger balance effect evaluation; the first confirmation unit is coupled to the trigger unit and is configured to confirm a theoretical balance capacity and an actual balance capacity reduction value; and the first calculation unit is coupled to the first confirmation unit and is configured to obtain the balance optimization parameter according to the theoretical balance capacity and the actual balance capacity reduction value; and a balance switch module coupled to the balance effect evaluation module and configured to control ON and OFF of the balance of the energy storage system at an edge end according to the balance optimization parameter, the balance ON/OFF module including an acquisition unit, a cell SOH update unit, a second calculation unit, a second confirmation unit, and a switch unit, wherein the acquisition unit is configured to acquire a cloud-based SOH and the balance optimization parameter; the cell SOH update unit is coupled to the acquisition unit and is configured to update SOHs of respective cells in a battery stack according to the cloud-based SOH and the balance optimization parameter; the second calculation unit is coupled to the cell SOH update unit and is configured to obtain an inter-cell capacity difference under a characteristic operating condition according to the updated SOHs of the respective cells in the battery stack; the second confirmation unit is coupled to the second calculation unit and is configured to confirm a passive balance time required by each cell according to the inter-cell capacity difference; and the switch unit is coupled to the second confirmation unit and is configured to control ON and OFF of balance of each cell according to the passive balance time required by the cell.

Compared with the prior art, the energy storage system balance management method based on cloud-edge collaboration and the system thereof provided in the present disclosure achieve at least the following beneficial effects.

The present disclosure provides an energy storage system balance management method based on cloud-edge collaboration and a system thereof. The energy storage system balance management method based on cloud-edge collaboration includes: acquiring operating data before and after balance of an energy storage system; evaluating, according to operating data before and after balancing the energy storage system and a balance time, a balance effect of the energy storage system to obtain a balance optimization parameter, including: recording an inter-cell capacity difference array before the balance starts; starting to balance an inter-cell capacity, and when an ON time of balance of the inter-cell capacity reaches a preset time, triggering balance effect evaluation; confirming a theoretical balance capacity and an actual balance capacity reduction value; and obtaining the balance optimization parameter according to the theoretical balance capacity and the actual balance capacity reduction value; and controlling ON and OFF of the balance of the energy storage system at an edge end according to the balance optimization parameter, including: acquiring a cloud-based SOH and the balance optimization parameter; updating SOHs of respective cells in a battery stack according to the cloud-based SOH and the balance optimization parameter; obtaining an inter-cell capacity difference under a characteristic operating condition according to the updated SOHs of the respective cells in the battery stack; confirming a passive balance time required by each cell according to the inter-cell capacity difference; and controlling ON and OFF of balance of each cell according to the passive balance time required by the cell. By use of the above solution, according to the balance optimization parameter, differences in cell consistency between battery clusters at the edge end can be reduced. Since the differences in cell consistency between battery clusters at the edge end are reduced, a circulating current between the battery clusters at the edge end can be reduced, thereby preventing damage to batteries due to an excessive circulating current between the battery clusters and ensuring use performance and use safety of the energy storage system. Besides, a reliable reference can also be provided for a stack controller at the edge end to analyze an inter-cell difference, and balance control accuracy can be improved.

Of course, any product implementing the present disclosure is not necessarily required to achieve all the above technical effects at the same time.

Other features of the present disclosure and advantages thereof will become clear from the following detailed description of exemplary embodiments of the present disclosure with reference to the accompanying drawings.

### DRAWINGS

In order that the disclosure may be well understood, there will now be described various forms thereof, given by way of example, reference being made to the accompanying drawings, in which:

The accompanying drawings, which are incorporated in and constitute part of the specification, illustrate embodiments of the present disclosure and, together with the description thereof, serve to explain the principles of the present disclosure.

FIG. 1 is a schematic flowchart of an energy storage system balance management method based on cloud-edge collaboration according to the present disclosure;

FIG. 2 is a schematic flowchart of evaluating, according to operating data before and after balance of an energy storage system and a balance time, a balance effect of the energy storage system to obtain a balance optimization parameter according to the present disclosure;

FIG. 3 is a schematic flowchart of obtaining the balance optimization parameter according to a theoretical balance capacity difference reduction value and an actual balance capacity reduction value according to the present disclosure;

FIG. 4 is a schematic flowchart of controlling ON and OFF of the balance of the energy storage system at an edge end according to the balance optimization parameter according to the present disclosure;

FIG. 5 is a schematic diagram of a balance effect of a plurality of cells before the balance optimization parameter is added in the prior art;

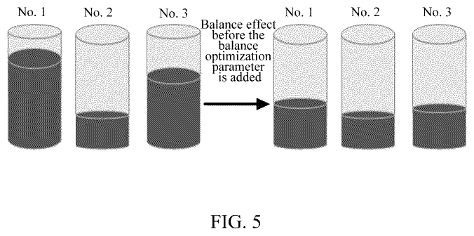

FIG. 6 is a schematic diagram of a balance effect of the plurality of cells after the balance optimization parameter is added in the prior art;

FIG. 7 is a schematic structural diagram of an energy storage system balance management system based on cloud-edge collaboration according to the present disclosure;

FIG. 8 shows a framework of the energy storage system balance management system based on cloud-edge collaboration according to the present disclosure; and

FIG. 9 is a schematic structural diagram of an energy storage system balance management device according to the present disclosure.

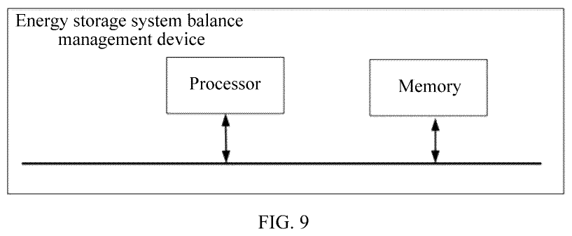

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Various exemplary embodiments of the present disclosure are now described in detail with reference to the accompanying drawings. It should be noted that, unless otherwise stated specifically, relative arrangement of components and operations, numerical expressions, and values set forth in the embodiments are not intended to limit the scope of the present disclosure.

The following descriptions of at least one exemplary embodiment are merely illustrative actually, and are not intended to limit the present disclosure and the applications or uses thereof.

Technologies, methods, and devices known to those of ordinary skill in the related art may not be discussed in detail, but such technologies, methods, and devices should be considered as part of the specification in appropriate situations.

In all examples shown and discussed herein, any specific values are to be construed as illustrative only and not as limiting. Therefore, other examples of the exemplary embodiments may have different values.

It should be noted that similar reference numerals and letters in the following accompanying drawings represent similar items. Therefore, once an item is defined in an accompanying drawing, the item does not need to be further discussed in the subsequent accompanying drawings.

During long-term operation of an energy storage system, due to a battery consistency difference and a battery temperature difference during use, consistency between cells increases with use. Especially for a centralized energy storage system, battery systems are connected in parallel on a DC side. An increased consistency difference between battery clusters may lead to an increased circulating current between the battery clusters, which may damage the batteries, lead to capacity attenuation, bulging, and leakage of the batteries, endanger safety of the batteries, and even result in safety risks in severe cases.

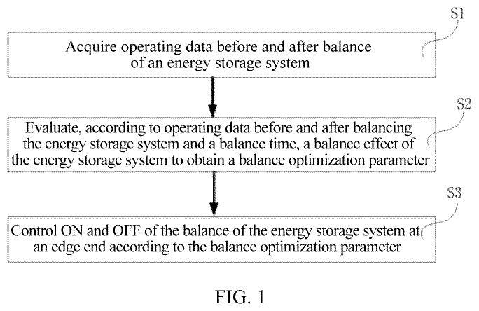

FIG. 1 is a schematic flowchart of an energy storage system balance management method based on cloud-edge collaboration according to the present disclosure. Referring to FIG. 1, this embodiment provides an energy storage system balance management method based on cloud-edge collaboration, including: S1: acquiring operating data before and after balance of an energy storage system; S2: evaluating, according to operating data before and after balancing the energy storage system and a balance time, a balance effect of the energy storage system to obtain a balance optimization parameter; and S3: controlling ON and OFF of the balance of the energy storage system at an edge end according to the balance optimization parameter.

For example, still referring to FIG. 1, in the energy storage system balance management method based on cloud-edge collaboration in this embodiment, cloud-edge collaboration refers to an information transfer and task allocation mechanism established between cloud computing and edge computing to achieve efficient collaboration of data processing and application services between a cloud end and an edge end, with a purpose of improving efficiency of data processing, reducing a delay, improving user experience, effectively utilizing a network bandwidth and computing resources, and reducing costs. A cloud is a central node of traditional cloud computing and a management and control end of edge computing. An edge is an edge side of cloud computing, which may be a subset of the cloud. The following steps are included.

In S1, the cloud end acquires operating data before and after balance of an energy storage system. Generally, the cloud end may store the operating data before and after balancing the energy storage system. In subsequent use, the operating data before and after balancing the energy storage system is read directly from the cloud end. The operating data before and after balancing the energy storage system acquired from the cloud end may be more accurate, more timely, and more comprehensive. The energy storage system includes batteries. Battery balance refers to application of differential currents to different batteries (or battery packs) in a series battery pack. The battery balance includes active balance and passive balance. The active balance is to perform balance by energy transfer to transfer batteries from high-energy cells to low-energy cells, thereby balancing a whole-group voltage. There is almost no energy loss involved in the transfer process. The passive balance is generally to discharge batteries with higher voltages through resistance discharge, releasing power in the form of heat to balance the whole-group voltage and gain more charging time for other batteries. The operating data may include a battery voltage, a battery temperature, a SOC, a SOH, a battery rate, and a charge/discharge capacity. For a rate, generally, magnitude of a charge/discharge current is expressed by a charge/discharge rate, where the charge/discharge rate=the charge/discharge current/a rated capacity. The charge/discharge capacity is a total amount of charge that a battery can accept or release under a specified charge/discharge condition, generally expressed in units of a product of time and current, which is Ah or mAh.

The battery includes a cell. The cell is a very important component in the battery. The cell is a semi-finished product. The battery may be used directly and is a finished product. The cloud end acquires the operating data before and after balancing the energy storage system to estimate the SOH of the battery stack, e.g., estimate SOHs of cells in the battery stack, which may also be understood as that the cloud end may use all operating data (a voltage, a temperature, a rate, and a charge/discharge capacity) of the energy storage system in a long cycle to analyze an aging state of the battery (e.g., a battery capacity is the most direct parameter that reflects the aging state of the battery, and specific manifestations of battery aging are as follows: a shortened battery life, battery expansion and deformation, and an excessively high battery temperature) to realize online estimation of the cloud-based SOH, which may subsequently provide a reference basis for the energy storage system at the edge end. For example, the cloud end uses all operating data of the energy storage system in a full life circle to establish a battery aging model, and optimizes model parameters based on current operating cell characteristic data to realize online estimation of the cloud-based SOH, which may be implemented, for example, with reference to the prior art (Application Publication Number CN114280494A, Application Publication Date: Apr. 5, 2022) as long as online estimation of the cloud-based SOH can be realized, or may be implemented with other embodiments according to actual situations. No specific limitations are made thereon in this embodiment. The edge end may be a battery management system (BMS). The BMS includes a circuit board or a controller.

The SOH refers to a battery capacity, a health degree, and a performance state, and may be understood as a ratio of a performance parameter after the battery has been used for a period of time to a nominal parameter, which is 100% for a new battery from a factory and is 0% for a completely scrapped battery. The SOH is a ratio of a capacity released by the battery discharged at a certain rate in a fully charged operating state to a cut-off voltage to a corresponding nominal capacity, which may be understood as an ultimate capacity of the battery.

In S2, according to operating data before and after balancing the energy storage system and a balance time, a balance effect of the energy storage system is evaluated to obtain a balance optimization parameter. According to the operating data before and after balancing the energy storage system and the balance time, the balance time is optimized based on an actual balance effect after balance. In S3, ON and OFF of the balance of the energy storage system at an edge end are controlled according to the balance optimization parameter. The above solution may be as follows: the cloud end acquires operating data before and after balancing the energy storage system in a long cycle; according to the operating data before and after balancing the energy storage system in the long cycle, the cloud end may evaluate the balance effect of the energy storage system online to obtain a balance optimization parameter, wherein the balance optimization parameter may provide a reliable reference for the energy storage system at the edge end to analyze an inter-cell difference; and the edge end may perform passive balance control over the energy storage system at the edge end according to the balance optimization parameter.

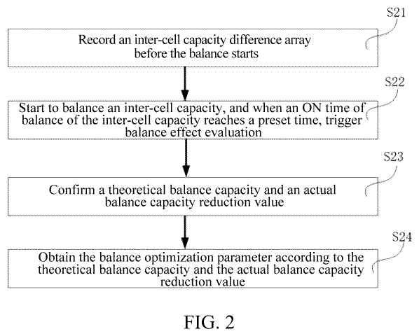

Referring to FIG. 2, FIG. 2 is a schematic flowchart of evaluating, according to operating data before and after balance of an energy storage system and a balance time, a balance effect of the energy storage system to obtain a balance optimization parameter according to the present disclosure. S2 of evaluating, according to operating data before and after balance of an energy storage system and a balance time, a balance effect of the energy storage system to obtain a balance optimization parameter includes:

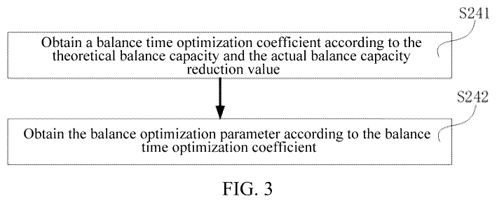

Referring to FIG. 2 and FIG. 3, S21 of recording an inter-cell capacity difference array before the balance starts; S22 of starting to balance an inter-cell capacity, and when an ON time of balance of the inter-cell capacity reaches a preset time, triggering balance effect evaluation; S23 of confirming a theoretical balance capacity and an actual balance capacity reduction value; and S24 of obtaining the balance optimization parameter according to the theoretical balance capacity and the actual balance capacity reduction value.

For example, in S21, the cloud end is responsible for recording an inter-cell capacity difference array Cap_{init,i} before the balance starts, where i denotes a cell number; and starting to balance an inter-cell capacity, and when an ON time of balance of the inter-cell capacity reaches a preset time, triggering balance effect evaluation once; wherein the preset time may be k×X h, where the value of k depends on a time of an actual balance action, for example, k=1, 2, 3, . . . until the end of the balance, and X may be a fixed value, such as 24 or 28, or may be adjusted according to an actual situation as long as the adjusted fixed value can ensure that the balanced capacity is no less than 2.5 Ah. For example, if the inter-cell capacity is actually balanced for 24 h, k=1. If the inter-cell capacity is actually balanced for 48 h, k=2. When balance effect evaluation is triggered once, cell capacity difference evaluation is performed when any characteristic operating condition is met, and the inter-cell capacity difference ΔCap_{k,i} in this case is recorded. The above characteristic operating condition includes full charge, full discharge, and low end. Full charge means being fully charged to 100% SOC with sufficient power. Full discharge means being fully discharged to 0% SOC with the battery power run out. Low end may mean confirming the theoretical balance capacity and the actual balance capacity reduction value at the end of battery discharge. The theoretical balance capacity may be a theoretical inter-cell capacity difference reduction value. The actual balance capacity reduction value may be an actual inter-cell capacity difference reduction value after this balance. The theoretical balance capacity may satisfy the following formula:

$$Δ {Cap}_{init , k} = BalCurr \times k \times X ;$$

where ΔCap_{init,k} denotes the theoretical balance capacity, which may be in units of mAh; the subscript k in ΔCap_{init,k} denotes a number of times balance optimization is triggered; BalCurr denotes a balance current, in units of mA; and k×X denotes the preset time, in units of h. The above balance current refers to a current used when a battery cell is balanced, which is a fixed value, and the balance current of each battery cell is the same. Through the above formula, the theoretical balance capacity may be obtained. The theoretical balance capacity serves as a basis for subsequently obtaining the balance optimization parameter.

For example, if BalCUrr=100 mA and the inter-cell capacity is actually balanced for 24 h, k=1.

ΔCap_{init,k}=100 mA×1×24 h=2400 mAh.

The actual balance capacity reduction value may satisfy the following formula:

$$Δ {Cap}_{k , i} = {Cap}_{init , i} - {Cap}_{k , i} ;$$

where ΔCap_{k,i} denotes the actual inter-cell capacity difference reduction value after this balance, which may be in units of mAh; Cap_{init,k} denotes the inter-cell capacity difference array, which may be an inter-cell capacity difference array before balancing and may be in units of mAh; and Cap_{k,i} denotes the inter-cell capacity difference, which may be an inter-cell capacity difference array after balance and may be in units of mAh. Through the above formula, the actual inter-cell capacity difference reduction value after this balance may be obtained. The actual inter-cell capacity difference reduction value after this balance serves as a basis for subsequently obtaining the balance optimization parameter.

It is to be noted that the actual balance capacity reduction value is related to the inter-cell capacity difference before and after balance. For example, a cell has a rated capacity of 280 Ah, a maximum capacity difference between cells is generally about 3% of the rated capacity, 8.4 Ah is obtained, and 6 difference values are provided. It is assumed that in the 6 difference values, one cell has poor consistency and the remaining cells have relatively good consistency. For example, if the inter-cell capacity difference array before balancing is [1.5, 1.55, 3.2, 8.3, 4.6, 3.9] and the inter-cell capacity difference array after balance is [0.8, 0.85, 1.8, 8, 2.7, 2.5], ΔCap_{k,i}=[1.5.1.55. 3.2,8.3, 4.6, 39]−[0.8,0.85.1.8,6.5,2.7,2.5]= [0.7,0.7,1,4,1.8,1.9,1.4], in units of Ah. 1 Ah=1000 mAh.

The above inter-cell capacity difference may be the inter-cell capacity difference uploaded by the edge end, and the cloud end directly acquires the inter-cell capacity difference subsequently, which is not limited in this embodiment.

Referring to FIG. 2 and FIG. 3, FIG. 3 is a schematic flowchart of obtaining the balance optimization parameter according to a theoretical balance capacity difference reduction value and an actual balance capacity reduction value according to the present disclosure. S3 of obtaining the balance optimization parameter according to the theoretical balance capacity and the actual balance capacity reduction value includes the following steps.

In S31, a balance time optimization coefficient is obtained according to the theoretical balance capacity and the actual balance capacity reduction value, wherein the balance time optimization coefficient may satisfy the following formula:

$${φ}_{k , i} = \frac{Δ {Cap}_{init , k}}{Δ {Cap}_{k , i}} ;$$

where φ_{k,i} denotes the balance time optimization coefficient, ΔCap_{init,k} denotes the theoretical balance capacity, and ΔCap_{k,i} denotes the actual balance capacity reduction value. In the solution, the theoretical balance capacity is divided by the actual balance capacity reduction value to obtain the balance time optimization coefficient. The balance time optimization coefficient provides a basis for obtaining the balance optimization parameter.

Taking ΔCap_{init,k}=2400 mAh=2.4Ah, Cap_{k,i}=[0.7,0.7,1.4,1.8,1.9,1.4] in units of Ah as an example,

$${φ}_{k , i} = \frac{24 Ah}{[ 0 , 7 , 0 , 7 , 1 , 4 , 1 , 8 , 1 , 9 , 1 A ] Ah} = [ 3.4 , 3.4 , 1.7 , 1.3 , 1.26 , 1.7 ] .$$

In S32, the balance optimization parameter is obtained according to the balance time optimization coefficient, wherein the balance optimization parameter may satisfy the following formula:

$${φ}_{i} = \frac{1}{n} \cdot {\sum }_{k = 1}^{n} {φ}_{k , i} ;$$

where φᵢ denotes a balance optimization coefficient, k denotes a number of times balance optimization is triggered, and n denotes a total number of times balance optimization is triggered. Through the above formula, the balance optimization parameter may be obtained. Through the balance optimization parameter, a reliable reference may be provided for differences between cells in the edge energy storage system, and can improve balance control accuracy in the energy storage system at the edge end. The balance optimization parameter may be in a range of 0.8 to 3.

In the above solution, firstly, the balance time optimization coefficient is obtained according to the theoretical balance capacity and the actual balance capacity reduction value; then, the balance optimization parameter is obtained according to the balance time optimization coefficient, a balance control effect evaluated by the cloud end is obtained, and a balanced remote adjustment parameter may be subsequently issued to a stack controller at the edge end, which may be the balance optimization parameter, thereby improving balance control accuracy of the stack controller at the edge end.

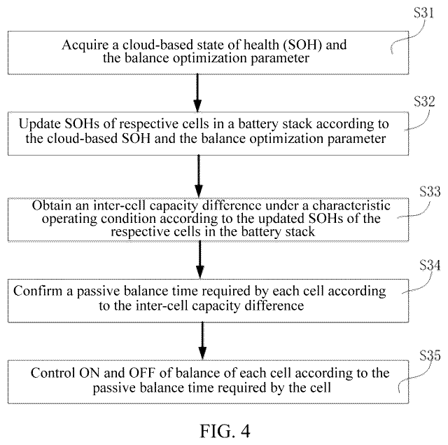

In some embodiments, refer to FIG. 4 which is a schematic flowchart of controlling ON and OFF of the balance of the energy storage system at an edge end according to the balance optimization parameter according to the present disclosure. S3 of controlling ON and OFF of the balance of the energy storage system at an edge end according to the balance optimization parameter includes:

S31 of acquiring a cloud-based SOH and the balance optimization parameter; S32 of updating SOHs of respective cells in a battery stack according to the cloud-based SOH and the balance optimization parameter; S33 of obtaining an inter-cell capacity difference under a characteristic operating condition according to the updated SOHs of the respective cells in the battery stack; S34 of confirming a passive balance time required by each cell according to the inter-cell capacity difference; and S35 of controlling ON and OFF of balance of each cell according to the passive balance time required by the cell.

For example, referring to FIG. 1 and FIG. 4, in S31, the stack controller at the edge end may acquire balance related data estimated by the cloud end. The balance related data estimated by the cloud end may include a cloud-based SOH and a balance optimization coefficient w. The cloud-based SOH may be a cell SOH obtained by a cloud-end server. The cloud-based SOH may be a SOH of all cells at the cloud end. The balance optimization coefficient $ is the above balance optimization parameter.

In S32, SOHs of respective cells in an edge-end battery stack are updated according to the cloud-based SOH and the balance optimization parameter, including confirming a balance SOH, where a local SOH may be a cell SOH obtained by the BMS, and the BMS may be an edge-end controller or an edge-end circuit board.

In S33, an inter-cell capacity difference is obtained under a characteristic operating condition (full charge, full discharge, or low end) according to the updated SOHs of the respective cells in the battery stack, wherein the inter-cell capacity difference may satisfy the following formula:

$$Δ {Cap}_{i} = {SOH}_{i} \times {Cap}_{N} \cdot ( {SOC}_{i} - {SOC}_{min} ) ;$$

where ΔCapᵢ denotes the inter-cell capacity difference, in units of mAh, SOHᵢ denotes a balance SOH, i denotes a cell number, Cap_{N} denotes a rated capacity, SOCᵢ denotes a SOC of an iₜₕ cell in the battery stack, and SOCₘᵢₙ denotes a minimum SOC in the battery pack.

The rated capacity refers to a measure of energy that a battery can store and release. This is an evaluation and calibration method for battery performance by battery suppliers and relevant standardization organizations, which may subsequently affect service time and performance of the battery.

The SOC is also referred to as the remaining capacity, which means a ratio of the remaining capacity of the battery after being left unused for a period of time to a capacity in a fully charged operating state, is generally expressed as a percentage, and ranges from 0 to 1. When SOC-0, it indicates that the battery is fully discharged, and when SOC=1, it indicates that the battery is fully charged.

In S34, a passive balance time required by each cell is confirmed according to the inter-cell capacity difference, wherein the passive balance time required by each cell may satisfy the following formula:

$${t}_{BAL , i} = \frac{{φ}_{i} \cdot Δ {Cap}_{i}}{{i}_{Bal}} ;$$

where t_{Bal,i} denotes the passive balance time required by each cell, φᵢ denotes a balance optimization coefficient, ΔCapᵢ denotes the inter-cell capacity difference, and i_{Bal} denotes a balanced average current. By use of the above formula, the passive balance time required by each cell may be obtained, which provides a basis for turning on or off the passive balance of the corresponding cell, and can also prevent an excessively long or short balance time of the corresponding cell, thereby improving accuracy of the passive balance of the corresponding cell.

It is to be noted that the inter-cell capacity difference obtained by the edge end may be directly uploaded to the cloud end, so that the cloud end obtains the actual balance capacity reduction value according to the inter-cell capacity difference.

In S35, ON and OFF of balance of the cell are controlled according to the passive balance time required by each cell, including:
when t_{BAL,i}>0, turning on balance of the corresponding cell; and
when, t_{BAL,i}=0, turning off balance of the corresponding cell.

It is to be noted that ON and OFF of balance of the corresponding cell are determined according to whether t_{BAL,i} is greater than or equal to 0, and if, t_{BAL,i}=0, there is no need to turn on the balance of the corresponding cell. The balance of the cell may be passive balance of the cell. ON and OFF of balance of the cell may be accurately controlled according to the passive balance time required by each cell.

In the above solution, the stack controller at the edge end may evaluate differences between the cells in the battery stack, and achieve high-accuracy balance control according to the balance related data evaluated by the cloud end.

As can be seen from the above embodiments, the energy storage system balance management method based on cloud-edge collaboration provided in this embodiment achieves at least the following beneficial effects.

This embodiment provides an energy storage system balance management method based on cloud-edge collaboration, including: acquiring operating data before and after balance of an energy storage system; evaluating, according to operating data before and after balancing the energy storage system and a balance time, a balance effect of the energy storage system to obtain a balance optimization parameter; and controlling ON and OFF of the balance of the energy storage system at an edge end according to the balance optimization parameter. By use of the above solution, according to the balance optimization parameter, differences in cell consistency between battery clusters at the edge end can be reduced. Since the differences in cell consistency between battery clusters at the edge end are reduced, a circulating current between the battery clusters at the edge end can be reduced, thereby preventing damage to batteries due to an excessive circulating current between the battery clusters and ensuring use performance and use safety of the energy storage system. Besides, a reliable reference can also be provided for a stack controller at the edge end to analyze an inter-cell difference, and balance control accuracy can be improved.

In some embodiments, the updating SOHs of respective cells in a battery stack according to the cloud-based SOH and the balance optimization parameter includes: obtaining a balance SOH according to a number of updates of the SOHs of the respective cells in historical 30 days and SOH₁, SOH₂, . . . , and SOHₙ, including: when n≥3 and max(SOHᵢₗ,SOH_{i,2}, . . . SOH_{i,n})−min(SOHᵢ₁,SOHᵢ₂, . . . , SOH_{i,n})≤1, the balance SOH=a local SOH, where i denotes a cell number, and SOH_{i,1} denotes the SOH of the iₜₕ cell most recently calculated in historical 30 days; when 1≤n≤2, the balance SOH=90%×the local SOH+10%×the cloud-based SOH; and when n=0, the balance SOH=50%×the local SOH+50%×the cloud-based SOH.

The balance SOH may be a cell health degree used in balance calculation.

It is to be noted that since operating data in a full life circle stored in the cloud end may be used for calculating a SOH at the cloud end but an interval between the operating data in the full life circle is longer than that for the local SOH, when the local SOH meets a calculation condition, the local SOH is obtained with high accuracy, and when the local SOH does not meet the calculation condition for a long time, the cloud-based SOH has high accuracy. It is to be noted that the above calculation condition may be n≥3 and max(SOH_{i,1},SOH_{i,2}, . . . , SOH_{i,n})−min(SOH_{i,1},SOH_{i,2}, . . . , SOH_{i,n})≤1, 1≤n≤2, or n=0.

By determining the accuracy of the local SOH and the cloud-based SOH, the balance SOH is assigned a relatively high-precision SOH value, and a basis for judgment may be a number of times SOH calculation is locally triggered or may be differences in SOH values calculated multiple times (the SOH may not change much in a short term, because if SOH calculation is locally triggered multiple times in historical 30 days and the differences are less than a certain value, the local SOH is considered reliable, that is, if SOH calculation is locally triggered multiple times in historical 30 days and a calculation deviation is small, the local SOH is considered to have high accuracy).

In the above solution, the balance SOH may be adjusted according to the number of updates of the SOHs of the respective cells in historical 30 days and SOH₁, SOH₂, . . . , and SOHₙ, and the balance SOH is obtained in the above three manners. At the same time, updated weights are obtained according to historical updates of the local SOH, and a weight update scheme is clarified, which improves accuracy of estimation of the balance SOH and provides a reliable reference for a local average inter-cell capacity difference. The cloud end implements estimation of the SOH of the battery stack, and the edge end combines estimation of the cloud-based SOH and the local SOH to provide a reliable reference for the edge end to analyze inter-cell differences in respective battery clusters.

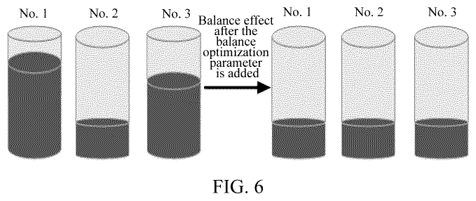

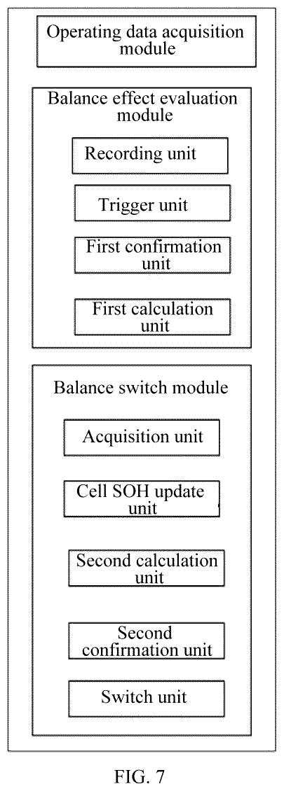

Referring to FIG. 6 and FIG. 7, FIG. 6 is a schematic diagram of a balance effect of the plurality of cells after the balance optimization parameter is added in the prior art; and FIG. 7 is a schematic structural diagram of an energy storage system balance management system based on cloud-edge collaboration according to the present disclosure. As shown in FIG. 6, capacities between three cells vary greatly, the three cells are passively balanced with the prior art, and after passive balance, the capacities between the three cells are inconsistent. For example, Cell No. 1 has the largest capacity, Cell No. 3 has the second largest capacity, and Cell No. 2 has the smallest capacity. As shown in FIG. 7, capacities between three cells vary greatly, the edge end passively balances the three cells by use of the present disclosure in combination with the balance optimization parameter, and after passive balance, the capacities between the three cells are consistent. For example, the capacities between Cell No. 1, Cell No. 2, and Cell No. 3 are consistent. Therefore, consistency differences between different cells are reduced.

Referring to FIG. 7, FIG. 7 is a schematic structural diagram of an energy storage system balance management system based on cloud-edge collaboration according to the present disclosure. This embodiment provides an energy storage system balance management system based on cloud-edge collaboration, configured to perform the energy storage system balance management method based on cloud-edge collaboration described above, the system including:
an operating data acquisition module configured to acquire operating data before and after balance of an energy storage system;
a balance effect evaluation module coupled to the operating data acquisition module and configured to evaluate, according to operating data before and after balancing the energy storage system and a balance time, a balance effect of the energy storage system to obtain a balance optimization parameter, the balance effect evaluation module including a recording unit, a trigger unit, a first confirmation unit, and a first calculation unit, wherein
the recording unit is configured to record an inter-cell capacity difference array before the balance starts;
the trigger unit is coupled to the recording unit and is configured to start to balance an inter-cell capacity, and when an ON time of balance of the inter-cell capacity reaches a preset time, trigger balance effect evaluation;
the first confirmation unit is coupled to the trigger unit and is configured to confirm a theoretical balance capacity and an actual balance capacity reduction value, wherein the theoretical balance capacity is:

$$Δ {Cap}_{init , k} = BalCurr \times k \times X ;$$

where ΔCap_{init,k} denotes the theoretical balance capacity; BalCurr denotes a balance current; and k×X denotes the preset time; and
the actual balance capacity reduction value is:

$$Δ {Cap}_{k , i} = {Cap}_{init , i} - {Cap}_{k , i} ;$$

where ΔCap_{k,i} denotes an actual inter-cell capacity difference reduction value after this balance; Cap_{init,i} denotes the inter-cell capacity difference array; and Cap_{k,i} denotes the inter-cell capacity difference; and

the first calculation unit is coupled to the first confirmation unit and is configured to obtain the balance optimization parameter according to the theoretical balance capacity and the actual balance capacity reduction value; and

a balance switch module coupled to the balance effect evaluation module and configured to control ON and OFF of the balance of the energy storage system at an edge end according to the balance optimization parameter, the balance ON/OFF module including an acquisition unit, a cell SOH update unit, a second calculation unit, a second confirmation unit, and a switch unit, wherein

the acquisition unit is configured to acquire a cloud-based SOH and the balance optimization parameter;

the cell SOH update unit is coupled to the acquisition unit and is configured to update SOHs of respective cells in a battery stack according to the cloud-based SOH and the balance optimization parameter;

the second calculation unit is coupled to the cell SOH update unit and is configured to obtain an inter-cell capacity difference under a characteristic operating condition according to the updated SOHs of the respective cells in the battery stack;

the second confirmation unit is coupled to the second calculation unit and is configured to confirm a passive balance time required by each cell according to the inter-cell capacity difference; and

the switch unit is coupled to the second confirmation unit and is configured to control ON and OFF of balance of each cell according to the passive balance time required by the cell.

According to the energy storage system balance management system based on cloud-edge collaboration, a balance optimization parameter is obtained according to operating data before and after the energy storage system completes balance multiple times and evaluated by the cloud end, and according to the balance optimization parameter, differences in cell consistency between battery clusters at the edge end can be reduced. Since the differences in cell consistency between battery clusters at the edge end are reduced, a circulating current between the battery clusters at the edge end can be reduced, thereby ensuring use performance and use safety of the energy storage system. Besides, a reliable reference can also be provided for a stack controller at the edge end to analyze an inter-cell difference.

Other details of the energy storage system balance management system based on cloud-edge collaboration according to some embodiments of the present disclosure are similar to the energy storage system balance management method based on cloud-edge collaboration according to some embodiments of the present disclosure described above with reference to FIG. 1 to FIG. 4, which are not described in detail herein again.

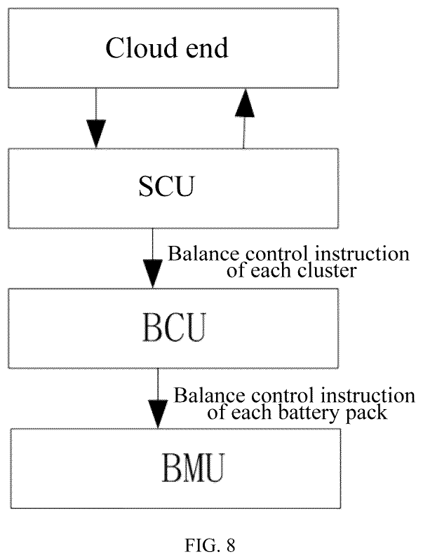

FIG. 8 shows a framework of the energy storage system balance management system based on cloud-edge collaboration according to the present disclosure. The framework may include four layers, namely a cloud end, a stack control unit (SCU), a battery cluster unit (BCU), and a battery module unit (BMU) respectively. The cloud end estimates the SOHs of the cells in the battery stack and evaluate the balance effect at the edge end according to operating data before and after balance completed multiple times. The SCU integrates a balance management algorithm of each cluster (battery cluster), and issues a balance control instruction to the BCU of each cluster. After the BCU receives the balance control instruction from the SCU, the BCU issues the balance control instruction to each BMU, and the BMU finally executes ON and OFF of passive balance. The battery cluster refers to a battery module including several battery cells.

This embodiment provides an energy storage system balance management device, including a memory and a processor.

The memory is configured to store executable program codes.

The processor is configured to read the executable program codes stored in the memory to perform the energy storage system balance management method based on cloud-edge collaboration.

The memory stores executable program codes. When the energy storage system balance management device operates, the processor and the memory communicate via a bus. When the executable program codes are executed, steps in an energy storage system balance management method based on cloud-edge collaboration in the embodiments shown in FIG. 1 to FIG. 4 above may be performed. Refer to the method embodiments for a specific implementation, which is not described in detail herein again.

As can be seen from the above embodiments, the energy storage system balance management method based on cloud-edge collaboration and the system thereof provided in the present disclosure achieve at least the following beneficial effects.

The present disclosure provides an energy storage system balance management method based on cloud-edge collaboration and a system thereof. The energy storage system balance management method based on cloud-edge collaboration includes: acquiring operating data before and after balance of an energy storage system; evaluating, according to operating data before and after balancing the energy storage system and a balance time, a balance effect of the energy storage system to obtain a balance optimization parameter; and controlling ON and OFF of the balance of the energy storage system at an edge end according to the balance optimization parameter. By use of the above solution, according to the balance optimization parameter, differences in cell consistency between battery clusters at the edge end can be reduced. Since the differences in cell consistency between battery clusters at the edge end are reduced, a circulating current between the battery clusters at the edge end can be reduced, thereby preventing damage to batteries due to an excessive circulating current between the battery clusters and ensuring use performance and use safety of the energy storage system. Besides, a reliable reference can also be provided for a stack controller at the edge end to analyze an inter-cell difference, and balance control accuracy can be improved.

Although some embodiments of the present disclosure have been described in detail by way of examples, those skilled in the art may understand that the above examples are for illustration only and are not intended to limit the scope of the present disclosure. Those skilled in the art may understand that the above embodiments may be modified without departing from the scope and spirit of the present disclosure. The scope of the present disclosure is defined by the appended claims.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method for balance-managing an energy storage system based on cloud-edge collaboration, comprising:
acquiring operating data before and after balancing an energy storage system;
evaluating, according to the operating data before and after balancing the energy storage system and balance time, a balance effect of the energy storage system to obtain a balance optimization parameter, comprising:
recording an inter-cell capacity difference array before the balancing starts; starting to balance an inter-cell capacity, and when ON time of the balancing reaches a preset time, triggering a balance effect evaluation; confirming a theoretical balance capacity and an actual balance capacity reduction value; and obtaining the balance optimization parameter according to the theoretical balance capacity and the actual balance capacity reduction value; and
controlling ON and OFF of the balancing of the energy storage system at an edge end according to the balance optimization parameter, comprising:
acquiring a cloud-based state of health (SOH) and the balance optimization parameter; updating SOHs of respective cells in a battery stack according to the cloud-based SOH and the balance optimization parameter; obtaining an inter-cell capacity difference under a characteristic operating condition according to the updated SOHs of the respective cells in the battery stack; confirming passive balance time required by each cell according to the inter-cell capacity difference; and controlling ON and OFF of the balancing of each cell according to the passive balance time.

2. The method according to claim 1, wherein the theoretical balance capacity is: ΔCap_{init,k}=BalCurr×k×X;
where ΔCap_{init,k} denotes the theoretical balance capacity; BalCurr denotes a balance current; and k×X denotes the preset time; and the actual balance capacity reduction value is:
$$Δ {Cap}_{k , i} = {Cap}_{init , i} - {Cap}_{k , i} ;$$
where ΔCap_{k,i} denotes an actual inter-cell capacity difference reduction value after a balancing; Cap_{init,k} denotes the inter-cell capacity difference array; and Cap_{k,i} denotes the inter-cell capacity difference.

3. The method according to claim 2, wherein the obtaining the balance optimization parameter according to the theoretical balance capacity and the actual balance capacity reduction value comprises:
obtaining a balance time optimization coefficient according to the theoretical balance capacity and the actual balance capacity reduction value; and
obtaining the balance optimization parameter according to the balance time optimization coefficient.

4. The method according to claim 3, wherein the balance time optimization coefficient is:
$${φ}_{k , i} = \frac{Δ {Cap}_{init , k}}{Δ {Cap}_{k , i}} ;$$
where φ_{k,i} denotes the balance time optimization coefficient, ΔCap_{init,k} denotes the theoretical balance capacity, and ΔCap_{k,i} denotes the actual balance capacity reduction value; and
the balance optimization parameter is:
$${φ}_{i} = \frac{1}{n} \cdot {\sum }_{k = 1}^{n} {φ}_{k , i} ;$$
where φᵢ denotes a balance optimization coefficient, k denotes a number of times to trigger balance optimization, and n denotes a total number of times to trigger balance optimization.

5. The method according to claim 1, wherein the updating SOHs of respective cells in the battery stack according to the cloud-based SOH and the balance optimization parameter comprises:
obtaining a balance SOH according to a number n of times for updating the SOHs of the respective cells in historical 30 days and SOH₁, SOH₂, . . . , and SOHₙ, comprising:
when n≥3 and max(SOH_{i,1},SOH_{i,2}, . . . , SOH_{i,n})−min(SOH_{i,1},SOH_{i,2}, . . . , SOH_{i,n})≤1, the balance SOH=a local SOH, where * denotes a cell number, and SOH_{i,1} denotes the SOH of a iₜₕ cell most recently calculated in historical 30 days;
when 1≤n≤2, the balance SOH=90%×the local SOH+10%×the cloud-based SOH; and
when n=0, the balance SOH-50%×the local SOH+50%×the cloud-based SOH.

6. The method according to claim 5, wherein the inter-cell capacity difference is:
$$Δ {Cap}_{i} = {SOH}_{i} \times {Cap}_{N} \cdot ( {SOC}_{i} - {SOC}_{min} ) ;$$
where SOHᵢ denotes the balance SOH, i denotes the cell number, Cap_{N} denotes a rated capacity, and SOCₘᵢₙ denotes a minimum state of charge (SOC) in the battery stack; and
passive balance time required by each cell is:
$${t}_{BAL , i} = \frac{{φ}_{i} \cdot Δ {Cap}_{i}}{{i}_{Bal}} ;$$
where φᵢ denotes a balance optimization coefficient, ΔCapᵢ denotes the inter-cell capacity difference, and i_{Bal} denotes a balanced average current.

7. The method according to claim 6, wherein the controlling ON and OFF of the balancing of each cell according to the passive balance time required by the cell comprises:
when t_{BAL,i}>0, turning on the balancing of the corresponding cell; and
when t_{BAL,i}=0, turning off the balancing of the corresponding cell.

8. The method according to claim 1, wherein the operating data before and after balancing the energy storage system comprises a battery voltage, a battery temperature, a SOC, a SOH, a battery rate, and a charge/discharge capacity.

9. The method according to claim 2, wherein the operating data before and after balancing the energy storage system comprises a battery voltage, a battery temperature, a SOC, a SOH, a battery rate, and a charge/discharge capacity.

10. The method according to claim 3, wherein the operating data before and after balancing the energy storage system comprises a battery voltage, a battery temperature, a SOC, a SOH, a battery rate, and a charge/discharge capacity.

11. The method according to claim 4, wherein the operating data before and after balancing the energy storage system comprises a battery voltage, a battery temperature, a SOC, a SOH, a battery rate, and a charge/discharge capacity.

12. The method according to claim 5, wherein the operating data before and after balancing the energy storage system comprises a battery voltage, a battery temperature, a SOC, a SOH, a battery rate, and a charge/discharge capacity.

13. The method according to claim 6, wherein the operating data before and after balancing the energy storage system comprises a battery voltage, a battery temperature, a SOC, a SOH, a battery rate, and a charge/discharge capacity.

14. The method according to claim 2, wherein X is adjusted to ensure that the balanced capacity ΔCap_{k,i} is no less than 2.5 Ah.

15. The method according to claim 4, wherein the balance optimization parameter may be in a range of 0.8 to 3.

16. The method according to claim 6, wherein the inter-cell capacity difference obtained by the edge end is directly uploaded to a cloud end, such that the actual balance capacity reduction value is obtained at the cloud end according to the inter-cell capacity difference.

17. The method according to claim 6, wherein a local SOH is a cell SOH obtained by a battery management system (BMS).

18. The method according to claim 6, wherein the BMS is an edge-end controller or an edge-end circuit board.

19. The method according to claim 6, wherein the characteristic operating condition comprises full charge, full discharge, and low end.

20. The method according to claim 1, wherein the method is performed by a balance management system for an energy storage system based on cloud-edge collaboration, and the balance management system comprises:
an operating data acquisition module configured to acquire operating data before and after balancing an energy storage system;
a balanced-effect evaluation module coupled to the operating data acquisition module and configured to evaluate, according to the operating data before and after balancing the energy storage system and balance time, a balance effect of the energy storage system to obtain a balance optimization parameter, and the balanced-effect evaluation module comprising a recording unit, a trigger unit, a first confirmation unit, and a first calculation unit, wherein
the recording unit is configured to record an inter-cell capacity difference array before the balancing starts;
the trigger unit is coupled to the recording unit and is configured to start the balancing of an inter-cell capacity, and when ON time of the balancing of the inter-cell capacity reaches a preset time, trigger balance effect evaluation;
the first confirmation unit is coupled to the trigger unit and is configured to confirm a theoretical balance capacity and an actual balance capacity reduction value; and
the first calculation unit is coupled to the first confirmation unit and is configured to obtain a balance optimization parameter according to the theoretical balance capacity and the actual balance capacity reduction value; and
a balance switch module coupled to the balance effect evaluation module and configured to control ON and OFF of the balancing of the energy storage system at an edge end according to the balance optimization parameter, wherein the balance ON/OFF module comprises an acquisition unit, a cell SOH update unit, a second calculation unit, a second confirmation unit, and a switch unit, wherein
the acquisition unit is configured to acquire a cloud-based SOH and the balance optimization parameter;
the cell SOH update unit is coupled to the acquisition unit and is configured to update SOHs of respective cells in the battery stack according to the cloud-based SOH and the balance optimization parameter;
the second calculation unit is coupled to the cell SOH update unit and is configured to obtain an inter-cell capacity difference under a characteristic operating condition according to the updated SOHs of the respective cells in the battery stack; the second confirmation unit is coupled to the second calculation unit and is configured to confirm passive balance time required by each cell according to the inter-cell capacity difference; and
the switch unit is coupled to the second confirmation unit and is configured to control ON and OFF of the balancing of each cell according to the passive balance time required by the cell.
